(19) United States
(12) Patent Application Publication
(10) Pub. No.: US 2022/0000148 A1
(43) Pub. Date: Jan. 6, 2022

(54) INSECTS' FEED

(71) Applicant: Cargill, Incorporated, Wayzata, MN (US)

(72) Inventors: Jean-Marie Aimé Louis POULAIN, Baupte (FR); Clémentine Catherine SEGUIMBRAUD, Isigny sur Mer (FR)

(73) Assignee: Cargill, Incorporated, Wayzata, MN (US)

(21) Appl. No.: 17/279,172

(22) PCT Filed: Sep. 25, 2019
(86) PCT No.: PCT/US2019/052873

§ 371 Date: Mar. 24, 2021

(30) Foreign Application Priority Data
Sep. 28, 2018 (EP) 18197445.2

(51) Int. Cl. A23K 20/163; A23K 50/90

(52) U.S. Cl. CPC A23K 20/163; A23K 50/90

(57) ABSTRACT

The present invention relates to an insects' feed containing a gel, said gel comprising: (i) a first polysaccharide being cassia gum, konjac gum and/or locust bean gum; (ii) a second polysaccharide different from the first polysaccharide, and (iii) at least 90 wt.-% water based on the total weight of the feed.

### CROSS-REFERENCE TO RELATED APPLICATIONS

This application claims the benefit of European Application No. 18197445.2, filed Sep. 28, 2018, entitled Insects' Feed, which is hereby incorporated by reference in its entirety,

The present invention relates to an insects' feed, a method of preparing the same as well as the use of the same for feeding insects.

It is known that insects can be used as a nutritional source for humans and/or animals Edible insects are rich in proteins and therefore have a high nutritional value. Approximately 2000 species of edible insects are known and this number is regularly increasing. Edible insects as nutritional source are particularly preferred from an ecological point of view, as for providing an equal nutritional value compared to conventional nutritional sources, such as animals, the CO₂ emission and water consumption is reduced. Moreover, edible insects as nutritional source are also preferred from an economical point of view, as for providing an equal nutritional value compared to conventional nutritional sources such as animals less farming space, feed and/or water are needed.

Apart from the food aspect, insects can function as a resource in various industrial fields. The exoskeleton of insects is constituted to a large extent by chitin, a known derivative of which is chitosan. As chitin and chitosan are biocompatible, biodegradable and non-toxic materials, these materials find use in cosmetic applications, such as cosmetic compositions, medical and pharmaceutical applications, such as pharmaceutical compositions, treatment of burns, biomaterials, corneal dressings, surgical sutures, dietetic and dietary applications, technical applications, such as filtering, texturing agents, from collating agents or adsorbents, in particular for water filtration or pollution control, etc.

Farming however insects to an industrial extent is difficult mainly due to challenges in feeding them and providing them with a source of water from which they can hydrate. The objective technical problem underlying the present invention is therefore to provide a cost efficient nutritional source for insects which provides the insects with water and optionally nutrients and which has optimal properties so that the insects can easily access it and feed on it.

The present invention relates to an insects' feed containing a gel, said gel comprising a first polysaccharide being cassia gum, konjac gum and/or locust bean gum, a second polysaccharide different from the first polysaccharide, and at least 60 wt.-% water based on the total weight of the feed.

An insects' feed is used to feed insects with water and preferably nutrients. If nutrients are included in the feed, preferably they are used in a quantity optimized to ensure at least a normal growth and development of the insects.

Polysaccharides are polymeric carbohydrate molecules composed of long chains of monosaccharide units bound together by glycosidic linkages, and upon hydrolysis may deliver constituents like monosaccharides or oligosaccharides. Polysaccharides can vary in structure from linear to highly branched.

The feed according to the invention (hereinafter the “inventive feed”) contains a gel or in other words is in the form of a gel. A feed in the form of a gel is herein understood as a feed which contains a 3-dimensional network with water trapped inside said network, the network being formed by the constituents of the feed e.g. at least the first polysaccharide being cassia gum, konjac gum and/or locust bean gum and the second polysaccharide being different from the first polysaccharide. The network provides the feed with a gel-like behavior, which can be expressed in terms of rheological properties such as firmness and/or cohesiveness as discussed herein-below.

The gel of the insects' feed according to the present invention comprises a first polysaccharide being cassia gum, konjac gum and/or locust bean gum. The term cassia gum refers to a gum obtainable from Senna obtusifolia and Senna tora. Konjac gum refers to a gum obtainable from the tuber of Amorphophallus konjac. Locust bean gum refers to a gum obtainable from the seeds of the carob tree.

Preferably, the first polysaccharide is present in amounts of 0.01 to 1.00 wt.-%, more preferably 0.05 to 0.80 wt.-%, even more preferably 0.07 to 0.70 wt.-% and most preferably 0.10 to 0.50 wt.-%. The term wt.-% relates to the percent by weight of the first polysaccharide in relation to the total weight of the insects' feed.

Preferably, as a first polysaccharide, the gel of the insects' feed comprises cassia gum in amounts of 0.01 to 1.00 wt.-%, more preferably 0.05 to 0.80 wt.-%, even more preferably 0.07 to 0.70 wt.-% and most preferably 0.10 to 0.50 wt.-%, konjac gum in amounts of 0.01 to 1.00 wt.-%, more preferably 0.05 to 0.80 wt.-%, even more preferably 0.07 to 0.70 wt.-% and most preferably 0.10 to 0.50 wt.-% and/or locust bean gum in amounts of 0.01 to 1.00 wt.-%, more preferably 0.05 to 0.80 wt.-%, even more preferably 0.07 to 0.70 wt.-% and most preferably 0.10 to 0.50 wt.-%.

The gel of the insects' feed according to the present invention further comprises a second polysaccharide different from the first polysaccharide, i.e. the second polysaccharide is free of cassia gum, konjac gum and/or locust bean gum. Hereby, it is understood that the first polysaccharide and the second polysaccharide are not the same polysaccharides. In case the first polysaccharide comprises more than one polysaccharide, the second polysaccharide is different to each of the polysaccharides in the first polysaccharide. Thus, the first polysaccharide and the second polysaccharide are structurally different from one another. By using different polysaccharides in the gellified insects' feed, an improved gel structure is provided which is able to incorporate the required amount of water.\

Preferably, the second polysaccharide is xanthan gum and/or carrageenan gum. Xanthan gum refers to a gum obtainable by a well-known fermentation process typically using a bacteria called Xanthomonas campestris. Carrageenan gum refers to a gum typically obtainable from red seaweed such as Chondrus crispus, Eucheuma Cottonii and Gigartina stellata.

Carrageenan gum preferably comprises a kappa-type carrageenan, e.g. more than 50 wt.-%, 75 wt.-%, 90 wt.-% kappa-type carrageenan. The remainder may comprise cellulose, proteins, iota and lambda carrageenan and other seaweed constituents. Kappa-type carrageenan is a linear carrageenan made up of a repeating dissacharide sequence of α-D-galactopyranose linked 1,3 and β-D-galactopyranose residues linked through positions 1,4 and can be represented by a repeating unit according to formula (I)

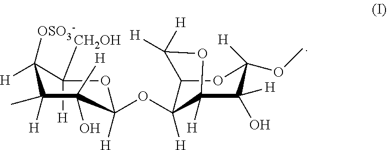

Preferably, the carrageenan gum comprising a kappa-type carrageenan is obtainable from Kappaphycus Alvarezii which is also sometimes referred to as Eucheuma Cottonii.

Preferably, the second polysaccharide is present in amounts of 0.01 to 1.00 wt.-%, more preferably 0.03 to 0.90 wt.-%, even more preferably 0.05 to 0.80 wt.-% and most preferably 0.07 to 0.70 wt.-%. The term wt.-% relates to the percent by weight of the second polysaccharide in relation to the total weight of the insects' feed.

Preferably, as a second polysaccharide, the gel of the insects' feed comprises xanthan gum in amounts of 0.01 to 1.00 wt.-%, more preferably 0.05 to 0.80 wt.-%, even more preferably 0.07 to 0.70 wt.-% and most preferably 0.10 to 0.50 wt.-% and/or carrageenan gum in amounts of 0.01 to 1.00 wt.-%, more preferably 0.05 to 0.80 wt.-%, even more preferably 0.07 to 0.70 wt.-% and most preferably 0.10 to 0.50 wt.-%.

The gel of the insects' feed according to the present invention further comprises at least 60 wt.-% of water based on the total weight of the feed. It was surprisingly observed that the inventive feed is able to contain such a high amount of water without jeopardizing the safety of the insects feeding on it. The gel of the invention has optimal cohesiveness and firmness. A cohesive gel prevents insects from drowning by getting trapped in the gel without the possibility to get out

It is important to also have an insects' feed having an optimal firmness in order for the insects to be able to take a good bite from it.

With the inventive feed, the insects are provided with an optimal amount of water during the feeding process. Preferably, the insects' feed can comprise at least 70 wt.-% of water, more preferably at least 80 wt.-%, even more preferably at least 90 wt.-%, yet even preferably at least 92 wt.-%, yet even more preferably at least 95 wt.-% of water and most preferably at least 97 wt.-% of water based on the total weight of the insects' feed. Preferably, the gel of the insects' feed comprises up to 99.5 wt.-% of water, more preferably up to 99.0 wt.-% of water and most preferred up to 98.0 wt.-% of water based on the total weight of the insects' feed.

In a preferred embodiment, the gel of the insects' feed comprises a combination of cassia gum as a first polysaccharide and xanthan gum as a second polysaccharide and at least 60 wt.-% water based on the total weight of the feed, cassia gum as a first polysaccharide and carrageenan gum as a second polysaccharide and at least 60 wt.-% water based on the total weight of the feed, konjac gum as a first polysaccharide and xanthan as a second polysaccharide and at least 60 wt.-% water based on the total weight of the feed, konjac gum as a first polysaccharide and carrageenan as a second polysaccharide and at least 60 wt.-% water based on the total weight of the feed or locust bean gum as a first polysaccharide and carrageenan as a second polysaccharide and at least 60 wt.-% water based on the total weight of the feed.

Preferably, the gel of the insects' feed can have a ratio of the first polysaccharide:second polysaccharide of 10:90 to 90:10, more preferably of 20:80 to 80:20, even more preferably 30:70 to 70:30 and most preferably 40:60 to 60:40.

Preferably, the gel of the insects' feed can further comprise a salt. Preferably, the salt is chosen from the group consisting of calcium salts, potassium salts and sodium salts. Non limiting examples of such salts include calcium chloride, calcium citrate, calcium sulfate, calcium phosphate, calcium lactate, sodium chloride, sodium sorbate, sodium citrate, potassium citrate, potassium chloride and/or potassium sorbate.

More preferably, the gel of the insects' feed comprises potassium chloride. The presence of potassium chloride in the insects' feed may positively influence the gel properties making it more suitable for feeding insects. Moreover, the presence of potassium chloride in the gel of the insects' feed may provide lowering the dosage of the first polysaccharide and the second polysaccharide and as a consequence may reduce the cost of the insects' feed. Moreover, the presence of potassium chloride in the insects' feed may positively influence various processing parameters, e.g. temperature needed to manufacture the inventive feed.

Typically, the gel of the insects' feed comprises the salt, preferably potassium chloride, in amounts of 0.05 to 3.0 wt.-%, more preferably between 0.07 to 2.5 wt.-%, most preferably 0.1 to 2.0 wt. %. The term wt.-% relates to the percent by weight of the salt, preferably potassium chloride, in relation to the total weight of the insects' feed.

In a preferred embodiment, the gel of the insects' feed comprises a combination of cassia gum as a first polysaccharide and xanthan gum as a second polysaccharide, potassium chloride and at least 60 wt.-% water based on the total weight of the feed, cassia gum as a first polysaccharide and carrageenan gum as a second polysaccharide, potassium chloride and at least 60 wt.-% water based on the total weight of the feed, konjac gum as a first polysaccharide and xanthan as a second polysaccharide, potassium chloride and at least 60 wt.-% water based on the total weight of the feed, konjac gum as a first polysaccharide and carrageenan gum as a second polysaccharide, potassium chloride and at least 60 wt.-% water based on the total weight of the feed or locust bean gum as a first polysaccharide and carrageenan gum as a second polysaccharide, potassium chloride and at least 60 wt.-% water based on the total weight of the feed.

Preferably, the insects' feed has a dry substance value of up to 40 wt.-%, more preferably 30 wt.-%, even more preferably 10 wt.-%, yet even more preferably 5 wt.-% and most preferably more than 3 wt.-%. The dry substance value is understood as the material in percentage by weight comprising all other constituents excluding water. The nutrient or mineral content of an animal feed are often expressed on a dry substance basis. The dry substance value can be calculated from the amount of solids used to manufacture the feed.

Preferably, the gel of the insects' feed further comprises a sugar. Preferably, the sugar is a monosaccharide or an oligosaccharide. More preferably, the sugar is chosen from the group of monosaccharides comprising fructose, mannose, galactose, glucose, dextrose, talose, gulose, allose, altrose, idose, arabinose, xylose, lyxose, sorbose and ribose; or from the group of oligosaccharides comprising sucrose, maltose, lactose, lactulose, and trehalosedextrose.

More preferably, the gel of the insects' feed further comprises dextrose.

Preferably the insects' feed comprises sugar, preferably dextrose, in amounts of 0.1 to 25.0 wt.-%, more preferably between 0.3 to 15.0 wt.-%, even more preferably between 0.5 to 10.0 wt. %, yet even more preferably between 0.5 to 5.0 wt.-%, yet even more preferably between 0.7 to 4.5 wt.-%, most preferably between 1.0 to 4.0 wt. %. The term wt.-% relates to the percent by weight of the sugar, preferably dextrose, in relation to the total weight of the insects' feed.

Preferably, the insects' feed further comprises nutrients, preservatives, minerals, proteins and/or vitamins.

The inventors observed that in order to optimally feed the insects, the gel contained by the inventive feed preferably has certain properties. One property of the gel is its ability to support the weight of one or more insects without allowing the insects to sink into the gel and therefore drowning therein. Typically, the feed is placed inside an environment containing the insects, which climb on it and walk on it to find a suitable place for feeding. To ensure that the safety of the insects while climbing, walking and feeding is not jeopardized, the gel preferably has a cohesiveness of at least 500 g, more preferably at least 800 g, even more preferably at least 1300 g, yet most preferably at least 1800 g. Preferably said cohesiveness is up to 20000 g, more preferably up to 15000 g, even more preferably up to 10000 g, most preferably up to 5000 g. In other words, the gel preferably has a cohesiveness of from 500 g to 20000 g, more preferably from 800 g to 15000 g, even more preferably from 1300 g to 10000 g and most preferably from 1800 g to 5000 g.

The cohesiveness can be measured with the Stable Micro Systems TA.XT2. In particular, the cohesiveness can be measured with the Stable Micro Systems TA.XT2 as described below in the Examples.

Another important property of the gel is its firmness. The gel should have the right texture to allow an optimal feeding. The inventors discovered that the inventive feed is optimal when the gel preferably has a firmness of at least 1 g, more preferably at least 3 g, most preferably at least 5 g. Preferably said firmness is up to 1500 g, more preferably up to 1000 g, even more preferably up to 500 g, most more preferably up to 200 g. In other words, the gel preferably has a firmness of from 1 g to 1500 g, preferably from 3 g to 1000 g, even more preferably from 5 g to 500 g and most preferably from 5 g to 200 g.

The firmness can be measured with the Stable Micro Systems TA.XT2. In particular, the firmness can be measured with the Stable Micro Systems TA.XT2 as described below in the Examples.

The present invention further relates to a method of preparing an insects' feed, the method comprising the steps of:
i. providing a gelling mixture having a gelling temperature in water, said mixture comprising a first polysaccharide and a second polysaccharide,
   wherein the first polysaccharide is cassia gum, konjac gum and/or locust bean gum,
   wherein the second polysaccharide is different from the first polysaccharide,
ii. adding the gelling mixture to water and mixing preferably at elevated temperatures to obtain an aqueous mixture having a gelling temperature;
iii. keeping the aqueous mixture at a temperature above the gelling temperature to prevent the formation of a gel;
iv. cooling the aqueous mixture to obtain an insects' feed;
v. optionally, breaking down the insects' feed into fragments.

According to the method of the present invention, as a step i. a gelling mixture having a gelling temperature in water is provided, wherein said mixture comprises a first polysaccharide and a second polysaccharide, wherein the first polysaccharide is cassia gum, konjac gum and/or locust bean gum and wherein the second polysaccharide is different from the first polysaccharide. With the expression that the gelling mixture has a gelling temperature in water, it is meant that the resulting gelling mixture is able to form a gel in water. The general definitions of a first polysaccharide and a second polysaccharide are identical with the above-described definitions of a first polysaccharide and a second polysaccharide of the insects' feed according to the present invention.

Preferably, the gelling mixture has a T_{gel} of more than 30° C. Preferably, the gelling mixture has a T_{gel} of up to 60° C. The T_{gel} is also referred to as the setting temperature. The T_{gel} or setting temperature describes the temperature at which the liquid gel is entirely gellified. The T_{gel} or setting temperature can be measured with the Perten RVA 4500 Rapid Visco Analyzer. In particular, the T_{gel} or setting temperature can be measured with the Perten RVA 4500 Rapid Visco Analyzer as described below in the Examples.

Providing a gelling mixture means that the first polysaccharide and the second polysaccharide are mixed with each other. In a preferred embodiment, the gelling mixture comprises a combination of cassia gum as a first polysaccharide and xanthan gum as a second polysaccharide, cassia gum as a first polysaccharide and carrageenan gum as a second polysaccharide, konjac gum as a first polysaccharide and xanthan as a second polysaccharide, konjac gum as a first polysaccharide and carrageenan as a second polysaccharide or locust bean gum as a first polysaccharide and carrageenan as a second polysaccharide.

Preferably, providing a gelling mixture can further comprise mixing a salt to the first polysaccharide and the second polysaccharide. Preferably, the salt is chosen from the group consisting of calcium salts, potassium salts and sodium salts. Non limiting examples of such salts include calcium chloride, calcium citrate, calcium sulfate, calcium phosphate, calcium lactate, sodium chloride, sodium sorbate, sodium citrate, potassium citrate, potassium chloride and/or potassium sorbate.

More preferably, the gel of the insects' feed comprises potassium chloride.

Preferably, the gelling mixture comprises the salt, preferably potassium chloride, in amounts of from 0.05 to 3.0 wt.-%, more preferably from 0.07 to 2.5 wt.-%, most preferably from 0.1 to 2.0 wt. %. The term wt.-% relates to the percent by weight of the salt, preferably potassium chloride, in relation to the total weight of the insects' feed.

In a preferred embodiment, the gelling mixture comprises a combination of cassia gum as a first polysaccharide and xanthan gum as a second polysaccharide and potassium chloride, cassia gum as a first polysaccharide and carrageenan gum as a second polysaccharide and potassium chloride, konjac gum as a first polysaccharide and xanthan as a second polysaccharide and potassium chloride, konjac gum as a first polysaccharide and carrageenan as a second polysaccharide and potassium chloride or locust bean gum as a first polysaccharide and carrageenan as a second polysaccharide and potassium chloride.

Preferably, the gelling mixture further comprises a sugar. Preferably, the sugar is a monosaccharide or an oligosaccharide. More preferably, the sugar is chosen from the group of monosaccharides comprising fructose, mannose, galactose, glucose, dextrose, talose, gulose, allose, altrose, idose, arabinose, xylose, lyxose, sorbose and ribose; or from the group of oligosaccharides comprising sucrose, maltose, lactose, lactulose, and trehalosedextrose.

More preferably, the gelling mixture further comprises dextrose.

Preferably, the insects' feed comprises sugar, preferably dextrose, in amounts of from 0.1 to 25.0 wt.-%, more preferably from 0.3 to 15.0 wt.-%, even more preferably from 0.5 to 10.0 wt. %, yet even more preferably from 0.5 to 5.0 wt.-%, yet more preferably from 0.7 to 4.5 wt.-%, most preferably from 1.0 to 4.0 wt. %. The term wt.-% relates to the percent by weight of the sugar, preferably dextrose, in relation to the total weight of the insects' feed.

Without wishing to be bound by theory, by adding the sugar, preferably dextrose, the gelling mixture is better solubilized in water due to a pre-dispersion of the powders sugar/gelling mixture. Thereby the formation of agglomerates or so-called “lumps” of gelling mixture in water can be avoided.

Preferably, the gelling mixture further comprises nutrients, preservatives, minerals, proteins and/or vitamins.

In a preferred embodiment, the gelling mixture comprises a combination of cassia gum as a first polysaccharide and xanthan gum as a second polysaccharide, potassium chloride and nutrients, preservatives, minerals, proteins and/or vitamins, cassia gum as a first polysaccharide and carrageenan gum as a second polysaccharide, potassium chloride and nutrients, preservatives, minerals, proteins and/or vitamins, konjac gum as a first polysaccharide and xanthan as a second polysaccharide, potassium chloride and nutrients, preservatives, minerals, proteins and/or vitamins, konjac gum as a first polysaccharide and carrageenan gum as a second polysaccharide, potassium chloride and nutrients, preservatives, minerals, proteins and/or vitamins or locust bean gum as a first polysaccharide and carrageenan gum as a second polysaccharide, potassium chloride and nutrients, preservatives, minerals, proteins and/or vitamins.

According to the method of the present invention, as a step ii. the gelling mixture is added to water and is mixed to obtain an aqueous mixture having a gelling temperature. The gelling mixture can be added to water in one complete portion and subsequently the gelling mixture in water is mixed or the gelling mixture can be added gradually under stirring to water. Preferably, the gelling mixture is added gradually under stirring to water. Preferably, the stirring of gelling mixture and water is conducted with a mixing system which is able to perform a strong shearing, such as a triblender. Thereby, the formation of agglomerates or lumps of the gelling mixture in water can be avoided.

The gelling mixture can be added to water at ambient temperature, i.e. at 20° C. to 25° C., or at elevated temperatures, i.e. at temperatures of 40° C. to 80° C., more preferably 45° C. to 75° C. and most preferably 50° C. to 70° C. Preferably, the gelling mixture is added to water at elevated temperatures of, i.e. at temperatures of 40° C. to 80° C., more preferably 45° C. to 75° C. and most preferably 50° C. to 70° C. Thereby, the polysaccharide can be mixed in water more homogeneously and the formation of agglomerates or “lumps” of the gelling mixture in water can be avoided.

According to the method of the present invention, as a step iii. the aqueous mixture is kept above its gelling temperature to prevent the formation of a gel. Hereby, it is understood that the aqueous mixture is kept above the gelling temperature of the entire gelling mixture. Preferably, the aqueous mixture is kept at a temperature of at least 30° C., at least 50° C. or at least 60° C.

According to the method of the present invention, as a step iv. the aqueous mixture is cooled to obtain an insects' feed. Hereby it is understood that the aqueous mixture is cooled to a temperature below T_{gel} or setting temperature so that the resulting product can be used as an insects' feed. Preferably, the gel is cooled to a temperature of at most 28° C., more preferably at most 24° C., most preferably at most 21° C.

According to the method of the present invention, as an optional step v. the obtained insects' feed can be broken down to fragments. The breaking of the insects' feed to fragments can be achieved by conventional methods known by the skilled person.

The present invention further relates to an insects' feed prepared by the method as described above.

The present invention further relates to a method of feeding insects, comprising providing to insects the feed as described above or the feed prepared by the method as described above.

The present invention further relates to a use of the insects' feed as described above or the feed prepared by the method as described above for feeding insects.

The present invention provides an insects' feed which has an optimal interrelationship of cohesiveness, firmness, gellification temperature and temperature of solubilizing. A good cohesiveness provides that the insects' feed cannot be easily destroyed, it is not sticky so that the insect gets trapped and ultimately dies within the insect feed and does not break, so that the insect gets trapped and ultimately dies. A good firmness provides that the insect can optimally feed thereon. An optimum gellification temperature ensures an optimal manufacturing and further processing of the feed. An optimum temperature of solubilizing the composition provides that in case the solubilizing temperature is too high in the process of preparing it and the final insects' feed is economically not viable due to the high-required amount of energy.

The present invention is also described by the following items:
1. An insects' feed containing a gel, said gel comprising
   a first polysaccharide being cassia gum, konjac gum and/or locust bean gum,
   a second polysaccharide different from the first polysaccharide, and
   at least 60 wt.-% water based on the total weight of the feed.
2. The feed according to item 1,
   wherein the second polysaccharide is xanthan gum and/or carrageenan gum.
3. The feed according to items 1 to 2,
   wherein the ratio first polysaccharide:second polysaccharide is 10:90 to 90:10, preferably 20:80 to 80:20 and more preferably 30:70 to 70:30.
4. The feed according to any one of items 1 to 3,
   wherein the gel of the insects' feed further comprises a salt.
5. The feed according to item 4,
   wherein the salt is chosen from the group consisting of calcium salts, potassium salts and sodium salts.
6. The feed according to any one of items 4 and 5,
   wherein the salt is potassium chloride.
7. The feed according to any one of items 1 to 6,
having a dry substance value of up to 40 wt.-%, 39 wt.-% or 10 wt.-%, preferably up to 5 wt.-% and even more preferably up to 3 wt.-%.
8. The feed according to any one of items 1 to 7,
   further comprising nutrients, preservatives, minerals, proteins, and/or vitamins
9. The feed according to any one of items 1 to 8,
   having a cohesiveness of at least 500 g, preferably 800 g, more preferably 1300 g and even more preferably 1800 g.
10. The feed according to any one of items 1 to 9,
   having a firmness of at least 1 g, preferably at least 3 g and more preferably at least 5 g; preferably up to 1500 g, more preferably up to 1000 g, even more preferably up to 500 g or most preferably up to 200 g.
11. The feed according to any one of items 1 to 10,
   having a T_{gel} of more than 30° C.
12. A method of preparing an insects' feed, the method comprising the steps of:
   i. providing a gelling mixture having a gelling temperature in water, said mixture comprising a first polysaccharide and a second polysaccharide,
      wherein the first polysaccharide is cassia gum, konjac gum or locust bean gum,
      wherein the second polysaccharide is different from the first polysaccharide,
   ii. adding the gelling mixture to water and mixing preferably at elevated temperatures to obtain an aqueous mixture;
   iii. keeping the aqueous mixture above the gelling temperature to prevent the formation of a gel;
   iv. cooling the aqueous mixture to obtain an insects' feed;
   v. optionally, breaking down the insects' feed into fragments.
13. The method according to item 12,
   wherein the ratio first polysaccharide:second polysaccharide is 10:90 to 90:10, preferably 20:80 to 80:20 and more preferably 30:70 to 70:30.
14. The method according to any one of items 12 and 13,
   wherein the gelling mixture further comprises a salt.
15. The method according to item 14,
   wherein the salt is chosen from the group consisting of calcium salts, potassium salts and sodium salts.
16. The method according to any one of items 14 and 15,
   wherein the salt is potassium chloride.
17. The method according to any one of items 12 to 16,
   wherein the gelling mixture further comprises a sugar, preferably a monosaccharide or an oligosaccharide.
18. The method according to any one of items 12 to 17,
   wherein the gelling mixture comprises dextrose.
19. The method according to any one of items 12 to 18,
   further comprising nutrients, preservatives, minerals, proteins, and/or vitamins
20. An insects' feed obtainable by the method of items 12 to 19,
21. A method of feeding insects, comprising providing to insects the feed according to items 1 to 11 or the feed prepared by the method of items 12 to 19.
22. A use of the insects' feed according to items 1 to 11 or the feed prepared by the method of items 12 to 19 for feeding insects.

### EXAMPLES

1. General Procedure for Preparing an Insects' Feed

Table 1 describes the constituents of the insects' feed according to the invention and not according to the invention.

TABLE 1
Constituents of the insects' feed according to the invention and not according to the invention.

| Entry | 109 | 84 | 83 | 78 | 79 | 88 | 108 | 100 | 77 | 97 | 92* |
|---|---|---|---|---|---|---|---|---|---|---|---|
| Ingredient 1 | Xanthan gum | | | Carrageenan gum | | Xanthan | Carrageenan | Xanthan | Carrageenan | Carrageenan | Native |
| | | | | | | gum | gum | gum | gum | gum | starch |
| Ingredient 2 | Cassia gum | | Konjac | Konjac | Locust | Konjac | Cassia gum | Konjac | Cassia gum | Cassia gum | |
| | | | gum | gum | bean gum | gum | | gum | | | |
| Ingredient 3 | Dextrose | Saccharose | Dextrose | | | | | | | | |
| Ingredient 4 | KCl | | NaCl | KCl | | | | | | KCl | |
| wt.-% | 0.28 | 0.28 | 0.34 | 0.34 | 0.36 | 0.34 | 0.15 | 0.34 | 0.26 | 0.26 | 5.00 |
| ingredient 1 | | | | | | | | | | | |
| wt.-% | 0.28 | 0.28 | 0.09 | 0.09 | 0.16 | 0.09 | 0.34 | 0.09 | 0.60 | 0.60 | |
| ingredient 2 | | | | | | | | | | | |
| wt.-% | 2.00 | 2.00 | 1.54 | 2.74 | 2.08 | 1.72 | 1.81 | 1.54 | 3.40 | 3.18 | |
| ingredient 3 | | | | | | | | | | | |
| wt.-% | 0.24 | 0.24 | 0.18 | 0.34 | 0.36 | | 0.15 | 0.18 | | 0.26 | |
| ingredient 4 | | | | | | | | | | | |
| wt.-% | 97.2 | 97.2 | 97.85 | 96.49 | 97.04 | 97.85 | 97.55 | 97.85 | 95.74 | 95.70 | 95 |
| water | | | | | | | | | | | |

*comparative

In the following, a general procedure for the preparation of an insects' feed with the constituents as described in Table 1 is provided. Each insects' feed was prepared in a total scale of 600 g.
1. Weigh and blend the powders of the recipe together with a spoon in a small cup.
2. In some cases, the water is heated in a pan until 60° C. roughly (thermostat 5 of the induction plate of the lab; this means the higher the integer of the thermostat, the higher the temperature of the pan is intended). In other cases the water is at room temperature.

| | 60° C. solubilization | Room temp. solubilization |
|---|---|---|
| Trial no | 109, 84, 83, 88, 100 | 92, 77, 78, 79, 97, 108 |

3. The powders blend is introduced slowly in the water in the pan under stirring with a manual whisk.
4. The solution is stirred with the manual whisk during 1 minute (at room temperature or in hot condition thermostat 4 depending on trial).
5. The solution in the pan goes through a dispersing device (DI 25 from Ika) during 1 minutes (no heating maintained during this step), the speed is adjusted to get a good vortex (variable depending on the viscosity of the solution).
6. The solution in the pan is brought back to the induction plate and the thermostat is set to 8 until boiling starts, under stirring with the manual whisk.
7. When boiling starts, the thermostat is set to 4 and the boiling is maintained for 5 minutes, under stirring with the manual whisk.
8. The pan containing the whisk and solution is weighted and hot water is added to compensate the evaporation.
9. The solution is poured into 3 glass crystallizers until overflowing and into small plastic pots.
10. For the crystallizers, the solution is leveled with a plastic cover and covered with this same cover.
11. The covered crystallizers and uncovered plastic pots are cooled down at room temperatures about 2-3 hours.
12. The plastic pots are covered and both crystallizers and plastic pots are stored at 10° C.
13. The gel strength measurement is done the day after at 10° C. with the crystallizers and the syneresis is visually assessed in the plastic pots.

For trial 92, instead of steps 5-7 the solution was heated for 30 minutes using a bain marie while manually stirring.

2. Measurement of Firmness and Cohesiveness of the Insects' Feed

In the following, a general procedure for the measurement of firmness and cohesiveness of the insects' feed is provided.

The equipment used is a Texture Analyser from Stable Micro Systems: TA.XT2. The software used is Exponent. The probe used is a cylinder.

The project set up is as below:

| | | |
|---|---|---|
| Caption | Value | Units |

| | |
|---|---|
| Test Mode | Compression |

| | | |
|---|---|---|
| Pre-Test Speed | 1.00 | mm/sec |
| Test Speed | 5.00 | mm/sec |
| Post-Test Speed | 10.00 | mm/sec |

| | |
|---|---|
| Target Mode | Distance |

| | | |
|---|---|---|
| Distance | 30,000 | mm |

| | |
|---|---|
| Trigger Type | Auto (Force) |

| | | |
|---|---|---|
| Trigger Force | 5.0 | g |

| | |
|---|---|
| Break Mode | Off |
| Stop Plot At | Start Position |
| Tare Mode | Auto |
| Advanced Options | On |
| Control Oven | Disabled |
| Wait for Temperature | Non |
| Frame Deflection Correction | Off (XT2 compatibility) |

The steps to follow are:
1. Switch on the texture analyzer and computer
2. Open the software
3. Open the project (see characteristics above)
4. Calibrate the penetrometer via the software with the 2 kg weight
5. Take the first crystallizer out of the fridge, place it under the probe and launch the measurement
6. Repeat for the second and third crystallizers
7. Create the average of the three curves obtained with the software
8. With the cursor, pick up the value of the strength at 4 mm penetration (it is called the “firmness”) and at the peak (it is called the “cohesiveness”)

3. Measuring of the Setting Temperature T_{gel} of the Insects' Feed

In the following, a general procedure for the measurement of the T_{gel} or setting temperature of the insects' feed is provided. Each insects' feed was prepared in a total scale of 100 g.

The equipment used is a RVA 4500 (Rapid Visco Analyser) from Perten. It is coupled to a recirculating chiller (Accel 250 LC from ThermoFisher scientific).

The software managing the equipment is TCW3 (ThermoCline for Windows).

The test characteristics are as below:

| Time (hh:mm:ss) | Type of function | Value |
|---|---|---|
| 00:00:00 | Temperature | 20 |
| 00:00:00 | Speed | 960 |
| 00:00:12 | Speed | 160 |
| 00:00:30 | Temperature | 20 |
| 00:05:10 | Temperature | 95 |
| 00:15:10 | Temperature | 95 |
| 00:31:30 | Temperature | 10 |
| 00:50:00 | End | |

### Tolerance (±° C.): 1

Sampling period: 4
The steps to follow are:
1. Switch on the RVA, recirculating chiller and computer.
2. Open TCW3.
3. Calibrate the RVA with the paddle alone at speed 160 until stability of the measurement.
4. Open the test (see characteristics above).
5. Weight the water into a 250 ml beaker.
6. Put the water under stirring with an Ika stirrer, Kelco blade, at 800 rpm.
7. Blend all the powders of the recipe in a small cup and add the blend slowly into the water.
8. Check that there is no powder stuck to the blade.
9. Maintain stirring for 10 minutes.
10. Fill the RVA cup with 20 g of this solution.
11. Insert the RVA cup inside the RVA equipment.
12. The measurement starts by itself.
13. Once the measurement is done, with the cursor, pick up the temperature when the viscosity starts to increase (starts of gelification).

4. Measuring of the Syneresis of the Insects' Feed

Syneresis describes the extraction or expulsion of a liquid from a gel. Syneresis of the insects' feed are measured by visual observation.

By visual observation, the gels of the insects' feed are classified as none (no syneresis) and + to ++++ (wherein + means less syneresis and ++++ means more syneresis).

5. Results of the Measurement of Firmness, Cohesiveness, Setting Temperature (T_{gel}) and Syneresis

In the following, the results of the measurement of firmness, cohesiveness, setting temperature (T_{gel}) and syneresis of the above-described gels according to Table 1 are provided in Table 2.

As can be seen in Table 2, all insects' feed according to the invention provided an optimal mixture of the key characteristics having a good firmness and cohesiveness as well as an optimal setting temperature or T_{gel} and showed no syneresis.

In contrast to the insects' feed according to the present invention, the comparative Example 92 not according to the invention showed low firmness and lower cohesiveness compared to the insects' feed according to the present invention.

TABLE 2
results of the measurement of firmness, cohesiveness,
setting temperature (T_{gel}) and syneresis

| Entry | 109 | 84 | 83 | 78 | 79 | 88 | 108 | 100 | 77 | 97 | 92* |
|---|---|---|---|---|---|---|---|---|---|---|---|
| Firmness (g) | 21 | 26 | 24 | 1293 | 741 | 24 | 496 | 26 | 342 | 1225 | 24 |
| Cohesiveness (g) | 1811 | 1737 | 2244 | 1757 | 983 | 2017 | 1854 | 2380 | 1468 | 3444 | 77 |
| Setting | 52 | 52 | 42 | 43 | 43 | 36 | 32 | 43 | 13 | 40 | N/A |
| temperature (° C.) | | | | | | | | | | | |
| Syneresis | None | None | None | None | None | None | + | None | + | None | None |

*comparative

1. An insects' feed containing a gel, said gel comprising
a first polysaccharide being cassia gum, konjac gum and/or locust bean gum,
a second polysaccharide different from the first polysaccharide, and
at least 90 wt.-% water based on the total weight of the feed.

2. The feed according to claim 1,
wherein the second polysaccharide is xanthan gum and/or carrageenan gum.

3. The feed according to claim 1, wherein the ratio of first polysaccharide:second polysaccharide is 10:90 to 90:10.

4. The feed according to claim 1, wherein the gel of the insects' feed further comprises a salt.

5. The feed according to claim 4, wherein the salt is potassium chloride.

6. The feed according to claim 1, having a dry substance value of up to 40 wt. %.

7. The feed according to claim 1, further comprising nutrients, preservatives, minerals, proteins, and/or vitamins.

8. The feed according to claim 1, having a cohesiveness of at least 500 g.

9. The feed according to claim 1, having a firmness of at least 1 g.

10. The feed according to claim 1, having a T_{gel} of more than 30° C.

11. A method of preparing an insects' feed, the method comprising the steps of:
i. providing a gelling mixture having a gelling temperature in water, said mixture comprising a first polysaccharide and a second polysaccharide,
wherein the first polysaccharide is cassia gum, konjac gum and/or locust bean gum,
wherein the second polysaccharide is different from the first polysaccharide,
ii. adding the gelling mixture and mixing to obtain an aqueous mixture having a gelling temperature;
iii. keeping the aqueous mixture above the gelling temperature to prevent the formation of a gel;
iv. cooling the aqueous mixture to obtain an insects' feed; and
v. optionally, breaking down the insects' feed into fragments.

12. A method for feeding insects, comprising providing to insects a feed containing a gel, said gel comprising:
a first polysaccharide being cassia gum, konjac gum and/or locust bean gum,
a second polysaccharide different from the first polysaccharide, and
at least 90 wt.-% water based on the total weight of the feed.

13. (canceled)

14. The feed according to claim 2, wherein the ratio of first polysaccharide:second polysaccharide is 10:90 to 90:10.

15. The feed according to claim 1, wherein the ratio of first polysaccharide:second polysaccharide is 20:80 to 80:20.

16. The feed according to claim 2, wherein the ratio of first polysaccharide:second polysaccharide is 20:80 to 80:20.

17. The feed according to claim 1, wherein the ratio of first polysaccharide:second polysaccharide 30:70 to 70:30.

18. The feed according to claim 2, wherein the ratio of first polysaccharide:second polysaccharide is 30:70 to 70:30.

19. The feed according to claim 1 further comprising a sugar.

20. The method according to claim 12, wherein the second polysaccharide is xanthan gum and/or carrageenan gum.

21. The method according to claim 12, wherein the ratio of first polysaccharide:second polysaccharide is 10:90 to 90:10.
